(19) United States
(12) Patent Application Publication
(10) Pub. No.: US 2025/0175431 A1
(43) Pub. Date: May 29, 2025

(54) METHODS AND ARRANGEMENTS FOR SERVICE FUNCTION CHAINING AND PACKET STEERING

(71) Applicant: Intel Corporation, Santa Clara, CA (US)

(72) Inventors: QIAN LI, Beaverton, OR (US); ZONGRUI DING, Portland, OR (US); XIAOPENG TONG, Beijing (CN); ALEXANDRE SASO STOJANOVSKI, Paris (FR); THOMAS LUETZENKIRCHEN, Taufkirchen (BY); ABHIJEET KOLEKAR, Portland, OR (US); SANGEETHA BANGOLAE, Portland, OR (US); SUDEEP PALAT, Cheltenham, Gloucestershire (GB); GENG WU, Portland, OR (US)

(73) Assignee: Intel Corporation, Santa Clara, CA (US)

(21) Appl. No.: 18/866,195

(22) PCT Filed: Jun. 29, 2023
(86) PCT No.: PCT/US23/26561

§ 371 Date: Nov. 15, 2024

Related U.S. Application Data
(60) Provisional application No. 63/357,494, filed on Jun. 30, 2022.

(51) Int. Cl. H04L 47/2475; H04W 28/10

(52) U.S. Cl. CPC H04L 47/2475; H04W 28/10

(57) ABSTRACT

Logic may identify, based on a service request received via the network interface, a service function chain comprising one or more instances of communication service functions, computing service functions, and data service functions in a network, wherein the one or more instances of communication service functions are associated with one or more instances of computing service functions and the one or more instances of data service functions. Logic may determine service-aware transport information associated with the service function chain. Logic may configure, via the one or more interfaces, the one or more instances of communication service functions, computing service functions, and data service functions for packet steering based on the service-aware transport information. And logic may parse a service label of a packet associated with a service identified in the service request to determine the service label and forward the packet to a service function based on the service label.

### CROSS REFERENCE TO RELATED APPLICATIONS

This application claims priority under 35 USC § 119 from U.S. Provisional Application No. 63/357,494, entitled “SERVICE FUNCTION CHAINING AND PACKET STEERING ALONG A SERVICE CHAIN”, filed on Jun. 30, 2022, the subject matter of which is incorporated herein by reference.

### TECHNICAL FIELD

Embodiments herein relate to wireless communications, and more particularly, to service function chaining and packet steering in a cellular network.

### BACKGROUND

Sixth generation technology for broadband cellular networks (6G) cloud-native system provides computing services to subscribers (mobile users, applications, etc.). Subscriber's computing tasks can be deployed in a 6G cloud-native system and leverage 6G computing services and may generate a significant amount of packet traffic from the user equipment through the 6G cloud-native system and back to the user equipment.

### BRIEF DESCRIPTION OF THE DRAWINGS

FIG. 1A depicts an embodiment of a system including base stations, user equipment, and cloud-based computing and data services interconnected via a communication network;

FIG. 1B depicts an embodiment of a system including user equipment, an access node, and function architecture for control plane and user plane service functions for service function chaining and packet steering such as the system shown in FIG. 1A; depicts an embodiment of a system including user equipment and a network with a FIG. 1C logical cluster for a service function chain with one or more access nodes and physically distributed computing and data services such as the systems shown in FIGS. 1A-1B;

FIG. 2 depicts embodiments of a base station and user equipment, such as the base station and the user equipment illustrated in FIGS. 1A-1C;

FIG. 3 depicts a flowchart of an embodiment for service function chaining and packet steering such as the embodiments described in conjunction with FIGS. 1A-1C and 2;

FIG. 4 depicts a flowchart of an embodiment for packet-based service-aware packet steering such as the embodiments described in conjunction with FIGS. 1A-1c, 2, and 3;

FIG. 5 depicts a flowchart of an embodiment for flow-based service-aware packet steering such as the embodiments described in conjunction with FIGS. 1A-1C, 2, 3, and 4;

FIG. 6 depicts a flowchart of an embodiment for service-aware packet steering such as the embodiments described in conjunction with FIGS. 1A-1C, 2-4, and 5;

FIG. 7 depicts alternative embodiments for frames of a packet for transport to and from physically distributed computing and data services such as the systems and processes described in conjunction with FIGS. 1A-1C, and 2-6;

FIG. 8 depicts an embodiment of protocol entities in wireless communication devices such as the base station and user equipment shown in FIGS. 1A-1C and 2;

FIG. 9 depicts embodiments of the formats of physical layer data units (PDUs) that form via baseband circuitry and RF transceiver circuitry such as the baseband circuitry and the RF transceivers shown in FIG. 2;

FIGS. 10A-B depicts embodiments of communication circuitry such as the components and modules shown in the user equipment and base station shown in FIG. 2;

FIG. 11 depicts an embodiment of a storage medium described herein;

FIG. 12 depicts an embodiment of an architecture of a system of a network such as the communication networks in FIGS. 1A-1C;

FIG. 13 depicts an embodiment of a device such as a base station or user equipment shown in FIGS. 1A-1C and 2;

FIG. 14 depicts an embodiment of interfaces of baseband circuitry such as the baseband circuitry shown in FIG. 2; and

FIG. 15 depicts an embodiment of a block diagram of components to perform functionality described herein such as the functionality described in conjunction with FIGS. 1A-1C, 2-9, 10A-10B, and 11-14.

### DETAILED DESCRIPTION OF EMBODIMENTS

The following is a detailed description of embodiments depicted in the drawings. The detailed description covers all modifications, equivalents, and alternatives falling within the appended claims.

Since a computing task can comprise a chain of services in distributed computing locations, mechanisms for service function chaining and steering/navigating packets along a service function chain may improve the performance of packet transmission for the chain of service functions. One approach may involve the application logic carrying service information (e.g., in the form of uniform resource indicator (URI)). A service instance may be discovered and chosen by the service mesh proxy function, evolved Service Communication Proxy (SCP) User Plane (eSCP-U). In this case, the service function operates in layer 7 and is transparent to underlaying networking layers.

Another approach may involve the service information being carried in the packet to traverse the underlay transport network (e.g., in packet header or label). A transport network node, a Communication Service Function (Comm SF) may direct packets to either a Computing Service Function (Comp SF) instance or next hop the Comm SF based on the service information and pre-configured packet forwarding rules. For this approach, the service mesh capability is not required, and the service function operates in layer 3.

Embodiments may employ a hybrid approach. For the hybrid approach, the transport layer may determine communication service function (Comm SF) and data service function (Data SF or DSF) instances and their represented service clusters based on the cluster-level service information carried in the transport layer. Within a service cluster, many embodiments use a service mesh for inter-service communication based on application logic. Some embodiments may enable service function chaining (SFC) by combining service-aware transport such as segment routing (e.g., SRv6, SR-MPLS, and/or the like) and service mesh so that the service aware transport is configured to steer the traffic along the Comm SF path (layer 3) to the Comp SFs and Data SFs that are gateways (GWs) for computing and data services. Segment Routing Internet Protocol version 6 (SRv6) and Segment Routing Multi-Protocol Label Switching (SR-MPLS) are source routing models. SRv6 is a next-generation IP bearer protocol that combines segment routing (SR) and Internet Protocol version 6 (IPv6). Utilizing existing IPv6 forwarding technology, SRv6 may implement network programming through flexible IPV6 extension headers. SRv6 advantageously reduces the number of required protocol types, offers great extensibility and programmability, and meets the diversified requirements of more new services. SRv6 may advantageously provide high reliability for cloud-based service applications.

SR-MPLS enables the ingress to control a service path or service function chain by performing label operations on packets. In addition, transit nodes do not need to maintain path information, reducing the pressure on the control plane. SR-MPLS may use a label forwarding table that, advantageously, may not contain a large number of labels, reducing the device resource usage.

Many embodiments comprise service logic circuitry to enable service function chaining (SFC) that combines service-aware transport such as segment routing (e.g., SRv6, SR-MPLS, and/or the like) and service mesh so that the service-aware transport is configured to steer the traffic along the Comm SF path (layer 3) to the Comp SFs and Data SFs that are gateways (GWs) for computing and data services. The service logic circuitry may introduce new functions to the network architecture such as a Service Orchestration and Chaining Function (SOCF), a Compute Control Function (Comp CF), a Compute Service Function (Comp SF), a Communication Control Function (Comm CF), a Communication Service Function (Comm SF), a Data Control Function (Data CF), a Data Service Function (Data SF), an Evolved service communication proxy (eSCP), a service infrastructure control function (SICF), and a Service registration function (SRF). The SOCF may discover, orchestrate, and chain up communication, computing, and data services provided by functions in the network. Upon receiving service requests from users, the SOCF may interact with Comp CF, Comm CF, and Data CF to identify Comp SF, Comm SF, and Data SF instances, respectively. The SOCF may configure service resources and generate the service chain context that may contain multiple Comp SF, Comm SF, and Data SF instances and their associated computing endpoints, traffic, and service QoS.

In many embodiments, the Comp CF and the Comp SF may be part of the computing service plane. The Comp CF may be a control plane function and may provide functionalities such as Comp SF management, computing task context generation and management (e.g., create, read, modify, delete), and interaction with the underlaying computing infrastructure for computing resource management. The Comp SF may be a user plane function and may serve as the gateway to interface computing service users (such as UEs) and computing nodes behind a Comp SF instance. Detailed Comp SF functionalities may include: parse computing service for data received from users to compute tasks executable by computing nodes; hold service mesh ingress gateway or service application program interface (API) gateway functionality; enforce service and charging policies; monitor performance and collect telemetry data. A Comp SF instance may serve as the user plane gateway for a cluster of computing nodes. A Comp CF instance may control one or multiple Comp SF instances.

The Comm CF and the Comm SF may be part of the communication service plane. The Comm CF may be a control plane function for managing Comm SF, creating communication sessions, configuring communication sessions, releasing communication sessions, and managing communication session context. The Comm SF is the user plane function for data transport. Comm SF may support service-aware transport.

The Data CF and the Data SF may comprise parts of the Data Service Plane. The Data CF may be a control plane function and may provide functionalities such as Data SF management, creating Data services, configuring Data services releasing Data services, and managing Data service context. The Data SF may be a user plane function and may serve as the gateway between data service users (such as UEs and network functions) and data service endpoints behind the gateway. Specific functionalities of the Data SF may include parsing data service user data and forwarding the user data to corresponding data service endpoints, generating charging data, and reporting data service status.

The eSCP and the SICF may provide service communication infrastructure for control plane services and user plane services. The eSCP may be evolved from the SCP in 5G (5th generation network functionality) with user plane service communication proxy capabilities being added. The eSCP may comprise two parts: eSCP-C and eSCP-U, for control plane service communication proxy and user plane service communication proxy, respectively. The SICF may control and configure eSCP instances in terms of service traffic routing policies, access rules, load balancing configurations, performance monitoring, etc.

The SRF may be a registry for system services provided in the user plane such as services provided by service endpoints behind Comp SF and Data SF gateways and services provided by a UE computing client service function (Comp CSF).

In many embodiments, the configurations for classification and traffic steering may be enabled in the user equipment (UE) Service Mesh (SM) proxy, Comm SF, and Comp/Data SFs. The UE may comprise a computing client service function (Comp CSF) with a SM proxy that may be part of a dedicated infrastructure layer (layer 7) for facilitating service-to-service communications between services or microservices using proxies. A service mesh may comprise network proxies paired with each service (or microservice) in an application and a set of task-management processes. The proxies are called the user plane (or data plane) and the management processes are called the control plane. The user plane intercepts calls between different services and processes the calls. The control plane coordinates the behavior of proxies.

In many embodiments, a UE may comprise a SM proxy for the user plane (SM proxy UP) for the N3 interface and a SM proxy for the control plane (SM proxy CP) for the N2 interface via an access network (AN) such as a radio access network (RAN). For RANs, the base station may execute code and protocols for E-UTRA, an air interface for base stations and interaction with other devices in the E-UTRAN such as the UE. The E-UTRA may include the radio resource management (RRM) in a radio resource control (RRC) layer.

In many embodiments, a logical cluster for service function chaining may be formed at the Comp SF level in the service orchestration and chaining stage by the SOCF. The logical cluster may span across multiple physical clusters with the advantage that, within a logical cluster, service mesh can be used for service discovery and routing. Comm SFs may operate in L3 and connect physical computing/data service clusters (gatewayed by Comp SF) into a logical cluster for a given service function chain. The service mesh proxies (eSCP-U gateway and eSCP-U) operate in L7 and may manage service function chaining within the logical service cluster.

In some embodiments, service logic circuitry may establish mechanisms for service function chaining and steering or navigating packets along a service chaining. The service logic circuitry may, in response to a service request, invoke the SOCF for a service orchestration and chaining procedure to select and chain up serving Comm SF, Data SF, and Comm SF instances. The service logic circuitry may form a logical service cluster of Comp SF and Data SF instances and their represented computing and data service clusters that may span across one or more physically distributed clusters within the cellular network or connected to the cellular network. The service logic circuitry may configure eSCP-Us within the logical service cluster with the needed information for service discovery, load balancing, addressing, access control, etc. The service logic circuitry may invoke the service infrastructure control function (SICF) for eSCP-U configuration by generating the configuration parameters based on the service function chain information received from the SOCF and the SRF.

In many embodiments, the service logic circuitry may invoke the SOCF to configure the RAN and the Comm SF with information for service aware transport. If service-aware transport is a flow-based scheme, the SOCF may configure the RAN and Comm SF with service function chain information for each flow, such as the Comp SFs' IP addresses that a flow needs to be steered to along a chain. If service-aware transport is a packet-based scheme, the SOCF may configure the RAN and Comm SF, which are at the entrance points of a service-aware transport segment, with service chain information to generate service labels for each packet entering the service chain segment (or service function chain segment).

For the flow-based scheme, upon receiving a packet from the UE for a computing service cluster and/or data service cluster, a first instance of a Comm SF may read the service label of the packet, operate on this service label (e.g., modify the service label to include service mesh information), and forward the packet to the corresponding Comp SF or Data SF gateway or to a second Comm SF in another physical resource of the cellular network or connected to the cellular network as identified by the service label. Upon receiving a L7 message constructed from the packet received from an instance of the Comm SF, the Comp SF or Data SF, an instance of a Comm SF may read the service mesh information carried in L7 service label of the packet and forward the packet to proper eSCP-U within its represented computing service cluster or data service cluster.

Similarly, upon receipt of a packet from a computing service cluster and/or data service cluster, the first instance of a Comm SF may read the service label of the packet, operate on this service label (e.g., modify the label to include service mesh information), and forward the packet to the corresponding UE via the corresponding RAN.

For the service-aware transport scheme, once a service function chain is requested and orchestrated by SOCF, a policy control function (PCF) of the control plane network functions (NFs) of the service logic circuitry may generate a service ID and bound the service ID to the service path. The Comm SF along the traffic path may be configured with the information such as full or partial labels for the service and next hop Comm SF IDs such as a port for an IP address. The service ID can be sent to UE via the RRC or sent by SOCF or SICF via non-access stratum protocol (NAS).

The service logic circuitry may also configure the service ID in the SM proxy UP of the Comp SF of the UE. When the micro-service on the UE sends the hypertest transfer protocol (HTTP) message to the SM proxy UP towards the microservices in the service chain, the service logic circuitry may add the service ID to the HTTP message (also referred to as the packet), e.g., as part of the URI, or metadata carried in the HTTP header or message body. The service logic circuitry of e.g., an xNB (6^{th} generation or later NodeB base station) may perform classification upon receipt of the HTTP message based on service ID. When receiving a packet, the service logic circuitry may invoke the Comm SF to check and operate on the label of the packet and forward the traffic towards the Comp SF. The Comp SF or Data SF may maintain or store a mapping of the service ID and the rest of the labels so that the labels can be added back when an outgoing packet arrives for steering the outgoing packet back to the UE.

Various embodiments may be designed to address different technical problems associated with packet transport for cloud computing via a network such as determining a process for registering a service based on a service request, determining a process by which to transmit a packet from a user equipment to one or more physically distributed cloud-based computing clusters and data clusters, determining a process by which to transmit a packet from one or more physically distributed cloud-based computing clusters and data clusters to the user equipment, and/or the like.

Different technical problems such as those discussed above may be addressed by one or more different embodiments. Embodiments may address one or more of these problems associated with packet transport for cloud-computing via a network such as a cellular network. For instance, some embodiments that address problems associated with packet transport for cloud-computing via a network may do so by one or more different technical means, such as, orchestrating, for a service request, a service function chain comprising: a computing service function (Comp SF), a data service function (Data SF), and a communication service function (Comm SF); determining service-aware transport information associated with the service function chain; configuring a radio access network (RAN) and a communication control function (Comm CF) based on the service-aware transport information; identifying, based on a service request received via the network interface, a service function chain comprising one or more instances of communication service functions, computing service functions, and data service functions in a network, wherein the one or more instances of communication service functions are associated with one or more instances of computing service functions and the one or more instances of data service functions; determining service-aware transport information associated with the service function chain; configuring, via one or more interfaces, the one or more instances of communication service functions, computing service functions, and data service functions for packet steering based on the service-aware transport information; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, 5G New Radio (NR) and/or 6G, technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-2020, IEEE 802.11ax-2021, IEEE 802.11ay-2021, IEEE 802.11ba-2021, and/or other specifications and standards, such as specifications developed by the Wi-Fi Alliance (WFA)

Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

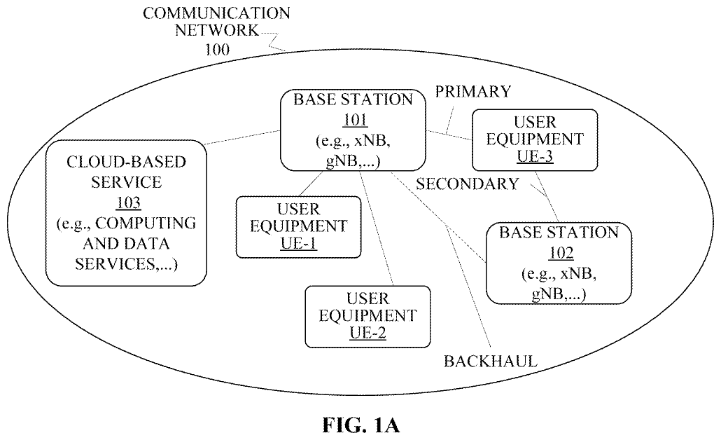

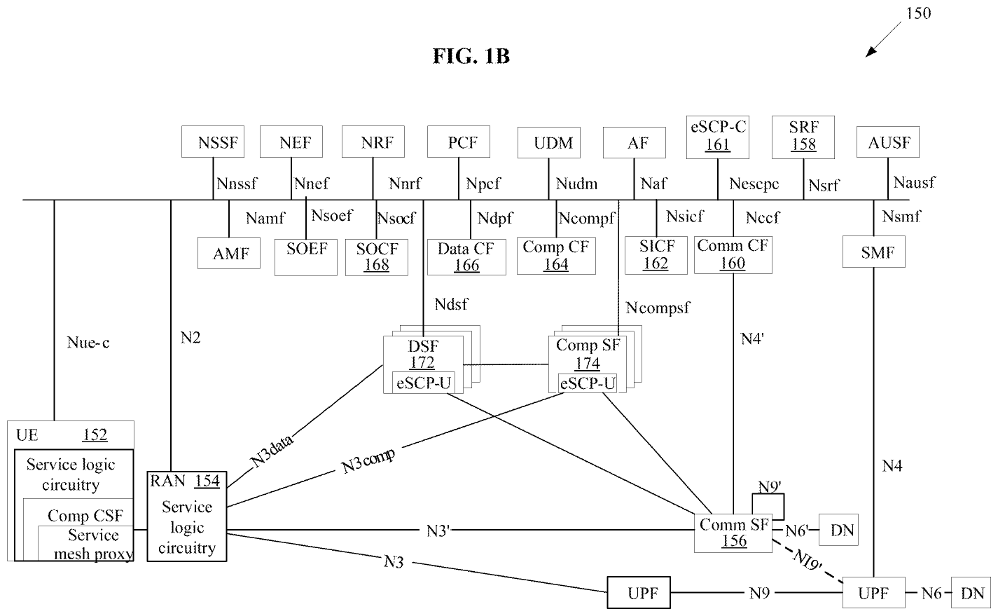

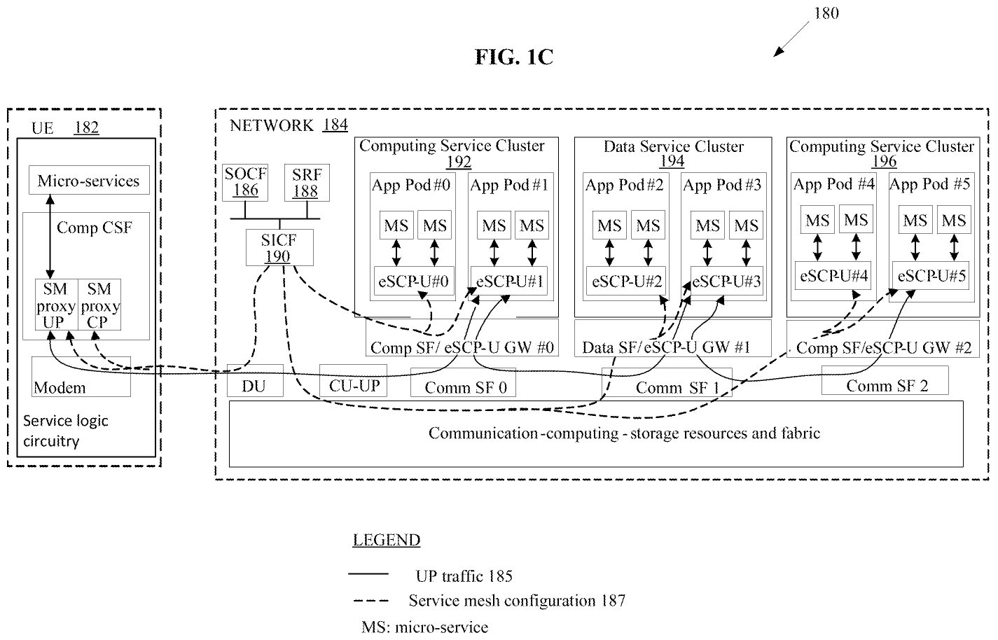

FIG. 1A illustrates a communication network 100 for service function chaining and packet steering. The communication network 100 is an Orthogonal Frequency Division Multiplex (OFDM) network comprising a primary base station 101, a secondary base station 102, a cloud-based service 103, a first user equipment UE-1, a second user equipment UE-2, and a third user equipment UE-3. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture.

The base stations 101 and 102 may communicate protocol data units (PDUs) via the backhaul.

As an example, for the Xn interface, the base station 101 may transmit or share control plane PDUs via an Xn-C interface and may transmit or share data PDUs via a Xn-U interface. For the F1 interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the base stations 101 and 102 may comprise service logic circuitry to for service function chaining and packet steering. The service logic circuitry may reside in the primary base station 101, the secondary base station 102, the cloud-based service 103, the first user equipment UE-1, the second user equipment UE-2, the third user equipment UE-3, or a combination thereof. In the present embodiment, the service logic circuitry resides in each of the primary base station 101, the secondary base station 102, the cloud-based service 103, the first user equipment UE-1, the second user equipment UE-2, and the third user equipment UE-3.

The cloud-based service 103, which may comprise one or more services and/or microservices and may reside in one or more physically distributed computing services and/or data services. The UE-3 may transmit a service request to the base station 102. For example, the UE-3 may comprise a software application that collects data via a first set of one or more microservices, performs one or more calculations and/or data manipulations on the data based on user interaction via a second set of one or more microservices, and stores data derived from the one or more calculations and/or data manipulations of the data via a third set of one or more microservices. Furthermore, the first, second, and third sets of microservices may reside on one or more physically distributed computing services and data services.

After or during association with the base station 102, the UE-3 may transmit a service request to the base station 102 to register the service with the base station 102. The base station 102 may comprise service logic circuitry to register the service by a service orchestration and chaining procedure that selects and chains up serving Comp SF, Data SF and Comm SF instances for a service request. The service logic circuitry of the base station 102 may identify, based on a service request received via a wireless network interface, a service function chain comprising one or more instances of Comm SFs, Comp SFs, and data SFs in the communication network 100. The one or more instances of Comm SFs may pass traffic to and from the UE-3 between the base station 102 and the cloud-based service 103. For instance, a first instance of the Comm SF may reside in the base station 102, a second instance of the Comm SF may reside in the base station 101, and one or more instances of the Comm SF may reside in the cloud-based service 103 at each of one or more computing server clusters and data server clusters that may reside at one or more physically and/or logically distinct locations. The service logic circuitry may identify a service function chain with hops between each of the instances of the Comm SFs for steering traffic from a first instance of the Comm SF in the base station 102 to a last instance of the Comm SF at the Comp SF or Data SF for each of the microservices associated with the service request from the UE-3.

The service logic circuitry may also identify instances of the Comp SFs and Data SFs associated with each of the computing server clusters and data server clusters associated with performance of the microservices for the service being registered by the UE-3. The instances of the Comp SFs and Data SFs may include evolved service communication proxies (eSCP) for the control plane and the user plane for the computing server clusters and data server clusters to act as gateways to the respective computing server clusters and data server clusters. Furthermore, each of the computing server clusters and data server clusters may include one or more application pods wherein each of the one or more application pods may be associated with sets of one or more microservices and the service logic circuitry may identify user plane proxies (eSCP-Us) for each of the one or more application pods. The instances of the Comp SF and Data SF instances and their represented computing/data service clusters identified by the service logic circuitry of the base station 102 may form a logical service cluster that spans across multiple physically distributed clusters.

After and/or during the identification of the instances of the Comm SFs, Comp SFs, Data SFs, and eSCPs, the service logic circuitry of the base station 102 may determine service-aware transport information associated with the service function chain to steer or navigate packets of traffic along the service function chain to and from the respective computing server clusters and data server clusters via the instances of the Comm SFs, Comp SFs, Data SFs, and eSCPs. For instance, the eSCP-Us within the logical service cluster may be configured with information for service discovery, load balancing, addressing, access control, and/or the like. The service logic circuitry of the base station 102 may perform the eSCP-U configuration via one or more instances of the service infrastructure control function (SICF) in the base station 102, in the base station 101, and/or in the cloud-based service 103. The one or more instances of the SICF may generate configuration parameters based on the service function chain information received from one or more instances of the service orchestration and chaining function (SOCF) and the service registration function (SRF).

The service logic circuitry of the base station 102 may invoke the SOCF and the communication control function (Comm CF) to configure the base station 102 (RAN) and the instances of the Comm SF with information for service-aware transport along the service function chain identified by the SOCF. In some embodiments, the service logic circuitry of the base station 102 may implement a flow-based scheme for service-aware transport of the traffic between the UE-3 and the computing server clusters and data server clusters associated with the service function chain. In some embodiments, the service logic circuitry of the base station 102 may implement a packet-based scheme for service-aware transport of the traffic between the UE-3 and the computing server clusters and data server clusters associated with the service function chain.

For the flow-based scheme, the service logic circuitry of the base station 102 may configure the base station 102 (RAN) and the instances Comm SF with service function chain information for each flow. For example, the service logic circuitry of the base station 102 may configure the base station 102 (RAN) and the instances of the Comm SF with Comp SFs' IP addresses and Data SFs' IP addresses that instances of the Comm SF may use to steer packets of the flow along the service function chain between the UE-3 and the respective computing server clusters and data server clusters. In such embodiments, each instance of the Comm SF may read the service label of a packet in the flow to determine the IP address of the Comp SF or Data SF that is the destination and each respective instance of the Comm SF may determine the instance of the Comm SF, Comp

SF, or Data SF that is the next hop (the next service function) along the service function chain based on the IP address of the Comp SF or Data SF. In many embodiments, the instances of the Comm SF may maintain a table for routing the packet flow that includes the IP address of the instances of the Comp SF or Data SF as well as an ID and/or address for the instance of the Comm SF, Comp SF, or Data SF that is the next hop (the next service function) along the service function chain.

For the packet-based scheme, the service logic circuitry of the base station 102 may configure the base station 102 (RAN) and Comm SF with service chain information to generate service labels for each packet entering a service chain segment. For example, the service logic circuitry of the base station 102 may configure the base station 102 (RAN) and the instance of the Comm SF at the entrance points of a service-aware transport segment with a service identifier (ID). The service logic circuitry may configure the subsequent instances of the Comm SF with, e.g., the IP address and/or port of the next hop based on the service ID so the instances of the Comm SF may use the service ID to steer packets of the traffic along the service function chain between the UE-3 and the respective computing server clusters and data server clusters. When receiving a packet, the instances of the Comm SF check and operate on the service label of the packet (e.g., read and add a destination for the next hop in the service label) and forward the traffic towards the instance of the Comp SF or Data SF that is at the destination for the packet.

In some embodiments, the instances of the Comp SF and the Data SF may maintain or store a mapping of the service ID and the rest of the labels so that the labels can be added back when an outgoing packet arrives from the respective computing server clusters and data server clusters. In other embodiments, the classification can be done at each Comm SF based on packet filters configured at the stage of service function chain setup by an instance of the communication control function (Comm CF). Each time an instance of the Comp SF receives outgoing traffic, the instance of the Comp SF is configured to send the outgoing traffic to a particular instance of the Comm SF that will send the outgoing traffic packets based on further classification at the particular instance of the Comm SF.

In some embodiments, the service logic circuitry may invoke an instance of the policy control function (PCF) of the base station 102 to generate the service ID and bound to the service path (e.g., configure instances of service functions with the service ID). An instance of the Comm SF along the traffic path may be configured with the service-aware transport information such as full or partial labels for the service ID and the next hop Comm SF IDs such as IP address: port.

In some embodiments, the service logic circuitry of the base station 102 may send the service ID to the UE-3 via the radio resource control layer (RRC) or sent by SOCF or SICF via a Non-Access Stratum (NAS) layer to configure an SM proxy UP of the computing client service function (Comp SCF) of the UE-3 with the service ID such that the service ID may be included each packet associated with the service. For instance, when the microservice on the UE-3 sends the HTTP message to the SM proxy UP towards the microservices in the service function chain, the SM proxy UP may add the service ID to the HTTP message, e.g., as part of the URI, or metadata carried in the HTTP header or message body.

FIG. 1B depicts an embodiment of a system 150 including user equipment (UE) 152, a radio access node (RAN) 154, and function architecture for control plane and user plane service functions for service function chaining and packet steering such as the system shown in FIG. 1A.

A SOCF 170 may form a logical cluster in the service orchestration and chaining stage after receipt of a service request from the UE 152 via a control interface, Nue-c, for the UE 152. The SOCF will interact with a Comp CF 164, a Comm CF 160, and a Data CF 166 to identify a Comp SF 174, a Comm SF 156, a Data SF 172 as well as other instances of the Comp SF 174, the Comm SF 156, and the Data SF 172 to form a logical service cluster.

The SOCF 168 may configure service resources and generate a service chain context, which may contain multiple Comp SF, Comm SF and Data SF instances and their associated computing endpoints, traffic, and service QoS. For instance, the SOCF may configure the instances of the Comm SF 156, the Comp SF 174, and the Data SF 172 for service-aware transport of between the UE 152 and the Comp SF 174 and the Data SF 172 as well as possibly other instances of the Comm SF, Comp SF, and the Data SF, e.g., via a data network (DN) through an N6 interface.

The Comp CF 164 and the Comp SF 174 may be parts of the computing service plane. The Comp CF 164 may be a control plane function and may provide functionalities such as Comp SF 174 management, computing task context generation and management (e.g., create, read, modify, delete), interaction with the underlaying computing infrastructure for computing resource management. The Comp SF 156 may be a user plane function and may serve as the gateway to interface computing service users (such as the UE 152) and computing nodes behind the comp SF 174 instance. The Comp SF 174 functionalities may include a parse computing service for data received from users to compute tasks executable by computing nodes; a hold service mesh ingress gateway or service API gateway; enforcement of service and charging policies; performance monitoring and telemetry data collection. The Comp SF 174 instance may serve as the user plane gateway for a cluster of computing nodes. The Comp CF 164 instance may control one or multiple Comp SF 174 instances.

The Comm SF 156 may provide service-aware transport for the service function chain established for a service by managing service function chaining at the Comp SF 174 level. The Comm SF 156 may operate in layer 3 (L3) and may connect physical computing and data service clusters, gatewayed by the Comp SF 174 and the Data SF 172, into a logical service cluster for the service function chain. In some embodiments, the Comp SF 174 and Data SF 172 instances and their represented computing/data service clusters may form a logical service cluster that spans across multiple physically distributed clusters.

The Comm CF 160 and the Comm SF 156 may be parts of the communication service plane. The Comm CF 160 may be a control plane function for managing the Comm SF 156; communication sessions creation, configuration, and releasing; and managing communication session context. The Comm SF 156 may be a user plane function for data transport and may support service-aware transport.

The Data CF 166 and the Data SF may be parts of the data service plane. The Data CF 166 may be a control plane function and may provide functionalities such as Data SF 172 management; data service creation, configuration, and release; and data service context management. The Data SF 172 may be a user plane function and may serve as the gateway between data service users (such as the UE 152 and network functions) and data service endpoints behind a gateway. The Data SF 172 may include functionalities such as a parse data service for user data, a service to forward to corresponding data service endpoints, a service to generate charging data, and a service to report data service status.

The SRF may be a registry for system services provided in the user plane such as services provided by service endpoints behind Comp SF and Data SF gateways and services provided by the Comp CSP of the UE 152.

The eSCP and the SICF 162 may provide service communication infrastructure for control plane services and user plane services. The eSCP may be evolved from the SCP in 5G with user plane service communication proxy capabilities being added. The eSCP comprises two parts: eSCP-C 161 and eSCP-U (part of Comp SF 174 and data SF 172), for control plane service communication proxy and user plane service communication proxy, respectively. The SICF 162 is defined to control and configure eSCP instances in terms of service traffic routing policies, access rules, load balancing configurations, performance monitoring, and/or the like.

The service mesh proxies, eSCP-U gateway of Comp SF 174 and eSCP-U gateway of the Data SF 172 may operate in layer 7 (L7) and may manage service function chaining within the logical service cluster. eSCP-Us within the logical service cluster may be configured with information to perform service discovery, load balancing, addressing, access control, and/or the like for the service function chain. The SICF 162 may configure the eSCP-U gateway of Comp SF 174 and eSCP-U gateway of the Data SF 172 and possibly other eSCP-Us connected to the RAN 154 or the DN. To perform the configuration, the SICF 162 may generate configuration parameters based on the service function chain information received from the SOCF 168 and the SRF 158.

The SOCF 168 and the Comm CF 160 may configure the RAN 154 and the Comm SF 156 with information for service-aware transport. If service-aware transport is a flow-based scheme, the SOCF 168 and the Comm CF 160 may configure the RAN 154 and the Comm SF 156 with service function chain information for each flow identified by, e.g., Comp SFs' IP addresses or Data SFs' IP addresses. The Comm SF 156 may read a service label in packets of a traffic flow to determine the Comp SFs' IP addresses and steer the packets in the traffic flow along the service function chain to the Comp SF 174.

If service-aware transport is a packet-based scheme, the SOCF 168 and the Comm CF 160 may configure the RAN 154 and the Comm SF 156 with service function chain information to generate service labels for each packet entering the service chain segment. In such embodiments, the SOCF 168 or the SICF 162, via a NAS, may send the service ID to the UE 152. The service logic circuitry of the UE 154 may configure the SM proxy UP of the Comp CSF with the service ID such that the SM proxy UP may add the service ID to outgoing packets from the UE 154 to the RAN 154 that are associated with the service.

Upon receiving a packet from the UE 152, the Comm SF 156 of the RAN 154 may read the first label of the packet, operate on this label such as pop or modify, and may forward the packet to the corresponding Comp SF 174 or Data SF 172 or another instance of the Comm SF via the DN or connected with the RAN 154, in accordance with the service ID identified in the service label.

Upon receiving a packet from Comm SF 156, the Comp SF 174 or the Data SF 172 may read the service mesh information carried in L7 information of the packet and forward the packet to proper eSCP-U (in L7) within its represented computing service cluster or data service cluster.

In some embodiments, the Comp SF 174 or the Data SF 172 may store a mapping between the service ID and the labels (of the service label) attached to the packet and attach the labels back to packets of outgoing traffic from the Comp SF 174 or the Data SF 172 that are marked with the same service ID. In other embodiments, the Comm SF 156 may perform classification based on packet filters configured by the Comm CF 160 and may attach the labels (as part of the service label) to packets of the outgoing traffic from one Comm SF 156 to another Comm SF (via the DN or connected with the RAN 154).

FIG. 1C depicts an embodiment of a system 180 including UE 182 and a network 184 with a logical service cluster for a service function chain with one or more access nodes and physically distributed computing and data services such as the systems shown in FIGS. 1A-1B. In the present embodiment, the UE 182 comprises service logic circuitry with microservices, a Comp CSF, and a modem. The Comp CSF may comprise a service mesh proxy user plane (SM proxy UP) and a SM proxy control plane (SM proxy CP).

The network 184 may comprise service functions SOCF 186, SRF 188, and SICF 190; and user plane functions for distributed unit (DU) communications and control unit user plane (CU UP) communications. The network 184 may also comprise Comm SFs to transport packets for a service along a service function chain of the logical service cluster including a Comp SF/eSCP-U GW #0, a Data SF/eSCP GW #1, and a Comp SF/eSCP GW #2 for a service function chaining of physically distributed computing and data clusters including a computing service cluster 192, a data service cluster 194, and a computing service cluster 196. Furthermore, the system 180 illustrates paths of communications including paths 185 for UP traffic and paths 187 for service mesh configuration.

In some embodiments, a logical service cluster is generated based on a service request from the service logic circuitry of the UE 182. The SOCF 186 may respond to the service request by identification of the logical service cluster that may include the computing service cluster 192, the data service cluster 194, and the computing service cluster 196. For the computing service cluster 192, the SOCF 186 may identify the corresponding Comm SF, the Comp SF/eSCP-U GW #0, the eSCP-U #0 for Application Pod #0, and the eSCP-U #1 for Application Pod #1. For the data service cluster 194, the SOCF 186 may identify the corresponding Comm SF, the Data SF/eSCP-U GW #1, the eSCP-U #2 for Application Pod #2, and the eSCP-U #3 for Application Pod #3. And for the computing service cluster 196, the SOCF 186 may identify the corresponding Comm SF, the Comp SF/eSCP-U GW #2, the eSCP-U #4 for Application Pod #4, and the eSCP-U #5 for Application Pod #5.

The Comp SF and Data SF instances may host the application service pods, eSCP-Us, a UE-side service proxy, and eSCP-U GWs for the respective computing service cluster 192, data service cluster 194, and computing service cluster 196. After identifying the logical service cluster, the control plane functions SOCF 186, SRF 188, and SICF 190 may generate the logical service cluster and configure the eSCP-U GWs and the eSCP-Us via the path 187 for service mesh configuration. Within the formed logical service cluster, the eSCP-U GWs and eSCP-Us in the L7 (based on uniform resource indicators (URIs) defined in application logics, load balancing and access control rules configured by SICF, etc.) may handle service discovery, load balancing, and communications. Furthermore, the SICF 190 may configure the SM proxy UP and SM proxy CP to include a service ID with each outgoing packet associated with the traffic flow for the service function chain of the logical service cluster.

For instance, a microservice of the UE 182 may generate a packet for the service function chain of the logical service cluster. The SM UP proxy of the Comp CSF of the UE 182 may add a service label to the outgoing packet to include the service ID. The packet may follow the path 185 for UP traffic through the DU function and the CU UP function to the Comm SF 0. The Comm SF 0 may be the first Comm SF at the entrance of the service function chain and may read the service ID and, perform classification to identify the endpoint of the service chain for the packet, perform an add operation to add information to the service label to identify one or more hops between Comm SFs (if applicable) and the endpoint, and forward the packet based on the endpoint. If the endpoint for the packet is a microservice (MS) in the computing service cluster 192, the Comm SF 0 may forward the packet to the Comp SF/eSCP-U GW #0. Otherwise, the Comm SF 0 may forward the packet to Comm SF of the next hop such as the Comm SF 1.

After receipt of the packet, the Comm SF 1 may read the service label to determine if the endpoint for the packet is in the data service cluster 194. If the endpoint for the packet is in the data service cluster 194, Comm SF 1 may forward the packet to the Comp SF/eSCP-U GW #1. Otherwise, the Comm SF 1 may forward the packet to Comm SF of the next hop such as the Comm SF 2.

After receipt of the packet, the Comm SF 2 may read the service label to determine if the endpoint for the packet is in the computing service cluster 196. If the endpoint for the packet is in the computing service cluster 194, Comm SF 2 may forward the packet to the Comp SF/eSCP-U GW #2.

After receipt of the packet at a gateway function such as the Comp SF/eSCP-U GW #0, the Comp SF/eSCP-U GW #1, or the Comp SF/eSCP-U GW #2, the gateway function may read the service mesh information carried in L7 of the packet to determine the packet is bound for a specific eSCP-U and forward the packet to that eSCP-U. For instance, the Comp SF/eSCP-U GW #2 may determine that the packet is bound for Application pod #5 and forward the packet to eSCP #5. In further embodiments, the Comp SF/eSCP-U GW #2 may determine that the packet is bound for eSCP #5 and forward the packet to eSCP #5 in Application pod #5. The eSCP #5 may read (or parse) the packet, determine the appropriate MS, and pass the packet to the appropriate MS.

In some embodiments, the gateway function such as the Comp SF/eSCP-U GW #0, the Comp SF/eSCP-U GW #1, or the Comp SF/eSCP-U GW #2 may store the labels of the service label for routing an outgoing packet from the gateway function along the service function chain to the UE 182 and add the labels to the service label of the packet to steer the packet along the service function chain to the UE 182.

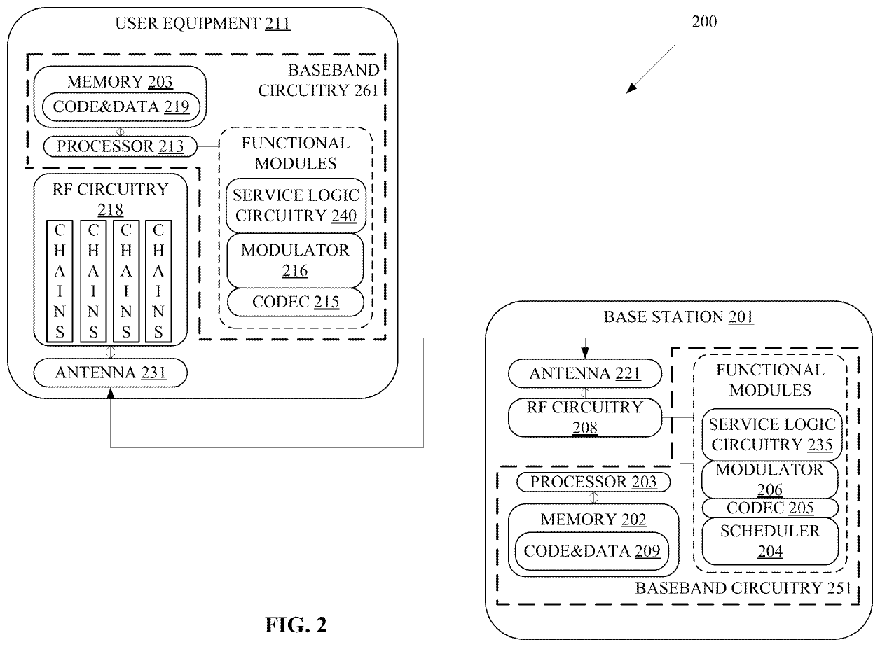

FIG. 2 is an embodiment of a simplified block diagram 200 of a base station 201 and a user equipment (UE) 211 that may carry out certain embodiments of the present invention in a communication network such as the base stations or RANs, the UEs, and communication networks shown in FIG. 1A-1C. For the base station 201, the antenna 221 transmits and receives radio signals. The RF circuitry 208 coupled with the antenna 221, which is the physical layer of the base station 201, receives RF signals from the antenna 231, converts the signals to digital baseband signals, or uplink data, and sends them to the processor 203 of the baseband circuitry 251, also referred to as the processing circuitry or baseband processing circuitry, via an interface of the baseband circuitry 251. The RF circuitry 208 also converts received, digital baseband signals, or downlink data, from the processor 203 via an interface of the baseband circuitry 251, converts them to RF signals, and sends the RF signals out to antenna 221.

The processor 203 decodes and processes the digital baseband signals, or uplink data, and invokes different functional modules to perform features in the base station 201. The memory 202 stores program instructions or code and data 209 to control the operations of the base station 201. The processor 203 may also execute code such as RRC layer code from the code and data 209 to implement RRC layer functionality.

A similar configuration exists in UE 211 where the antenna 231 transmits and receives RF signals. The RF circuitry 218, coupled with the antenna, receives RF signals from the antenna 221, converts them to baseband signals, or downlink data, and sends them to processor 213 of the baseband circuitry 261 via an interface of the baseband circuitry 261. The RF circuitry 218 also converts digital baseband signals, or uplink data, from the processor 213, converts them to RF signals, and sends out the RF signals to the antenna 231.

The RF circuitry 218 illustrates multiple RF chains. While the RF circuitry 218 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 218 may include transmitter circuitry and receiver circuitry, which is often called transceiver circuitry. The transmitter circuitry may prepare digital data from the processor 213 for transmission through the antenna 231. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 213 decodes and processes the digital baseband signals, or downlink data, and invokes different functional modules to perform features in the UE 211. The memory 212 stores program instructions or code and data 219 to control the operations of the UE 211. The processor 213 may also execute medium access control (MAC) layer code of the code and data 219 for the UE 211. For instance, the MAC layer code may execute on the processor 213 to cause UL communications to transmit to the base station 201 via one or more of the RF chains of the physical layer (PHY). The PHY is the RF circuitry 218 and associated logic such as some or all the functional modules.

The base station 201 and the UE 211 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 203 (e.g., via executing program code 209) is a functional block to configure and implement the circuitry of the functional modules to allow the base station 201 to schedule (via scheduler 204), encode or decode (via codec 205), modulate or demodulate (via modulator 206), and transmit data to or receive data from the UE 211 via the RF circuitry 208 and the antenna 221.

The processor 213 (e.g., via executing program code in the code and data 219) may be a functional block to configure and implement the circuitry of the functional modules to allow the UE 211 to receive or transmit, de-modulate or modulate (via de-modulator 216), and decode or encode (via codec 215) data accordingly via the RF circuitry 218 and the antenna 231. Both the UE 211 and the base station 201 may include a functional module, service logic circuitry 240 and 235 respectively. The service logic circuitry 235 of the base station 201 may cause the processor to perform actions to identify, based on a service request received via the network interface, a service function chain comprising one or more instances of communication service functions, computing service functions, and data service functions in a network. Based on the identification of the service function chain, the service logic circuitry 235 of the base station 201 may cause the processor to perform actions to determine service-aware transport information associated with the service function chain; and configure, via the one or more interfaces, the one or more instances of communication service functions, computing service functions, and data service functions for packet steering based on the service-aware transport information. For instance, the processor 203 may cause the service logic circuitry of the base station 201 to configure an SM proxy of the service logic circuitry 240 of the UE 211, one or more instances of Comm SFs, one or more instances of Comp SFs, one or more instances of Data SFs, and one or more instances of eSCPs with service-aware transport information. After configuring the service function chain with the service-aware transport information, the service logic circuitry 235 may perform packet steering or navigation to transmit packets from the UE 211 to one or more distributed physical computing service clusters and data service clusters along the service function chain. Furthermore, the service logic circuitry 235 may perform packet steering or navigation to transmit packets from the one or more distributed physical computing service clusters and data service clusters along the service function chain to the UE 211. In some embodiments, the service logic circuitry 240 of the UE 211 may add a service label to the header of outgoing packets such as adding a service ID to a header of an outgoing packet bound for the service function chain orchestrated by the service logic circuitry 235 of the base station 201.

FIG. 3 depicts a flowchart 3000 of an embodiment for service function chaining and packet steering such as the embodiments described in conjunction with FIGS. 1A-1C and 2. The flowchart 3000 begins with service logic circuitry of an access node of a cellular network with a cloud-computing service identifying, based on a service request received via the network interface, a service function chain (element 3005). The service function chain may comprise one or more instances of communication service functions, computing service functions, and data service functions in a network. The one or more instances of communication service functions are associated with one or more instances of computing service functions and the one or more instances of data service functions.

After identifying the service function chain, the service logic circuitry may determine service-aware transport information associated with the service function chain (element 3015). The service logic circuitry may invoke an instance of a SOCF to interact with a Comp CF, a Comm CF, and a Data CF to identify Comp SF, Comm SF, and Data SF instances, determine service resources, and determine the service function chain context, which may contain multiple instances of Comp SF, Comm SF and Data SF and their associated computing endpoints, traffic, and service QoS. SOCF and Comm CF instances may determine configurations for the RAN and Comm SF for service-aware transport. SICF instances may generate configuration parameters for eSCP-Us based on the service chain information received from SOCF and SRF. The configuration parameters may comprise information for service discovery, load balancing, addressing, access control, and/or the like.

After or during the determination of the service-aware transport information, the service logic circuitry may configure, via one or more interfaces, the one or more instances of communication service functions, computing service functions, and data service functions for packet steering based on the service-aware transport information (element 3015). In some embodiments, the SOCF and Comm CF instances may configure the RAN and Comm SF for service-aware transport and the SICF instances may configure the eSCP-Us with the configuration parameters.

FIG. 4 depicts a flowchart 4000 of an embodiment for packet-based service-aware packet steering such as the embodiments described in conjunction with FIGS. 1A-1c, 2, and 3. The flowchart 4000 begins with service logic circuitry of one or more nodes of a cellular network with cloud-based computing parsing a packet comprising a service label (element 4005). The service logic circuitry may parse a packet of a traffic flow at an instance of a Comm SF in a service function chain to determine a service ID for the packet (element 4010). The service ID may comprise an ID generated for and assigned to a service by an instance of a PCF and bound to the service function chain path in response to a service request by a user equipment. The instance of the Comm SF may read the service ID from the packet header or a frame body of the packet and for identifying a next hop for the packet along the service function chain.

After determining the service ID and based on a configuration of the instance of the Comm SF such as full or partial labels for the service and next hop Comm SF IDs such as IP address: port, the Comm SF may identify routing information for the packet such as the next hop for the packet to a Comp SF, a Data SF, or another instance of a Comm SF (element 4015). Once the Comm SF determines an address for the next hop, the Comm SF may pass the packet to the next service function along the service function chain associated based on the address for the next hop (element 4020).

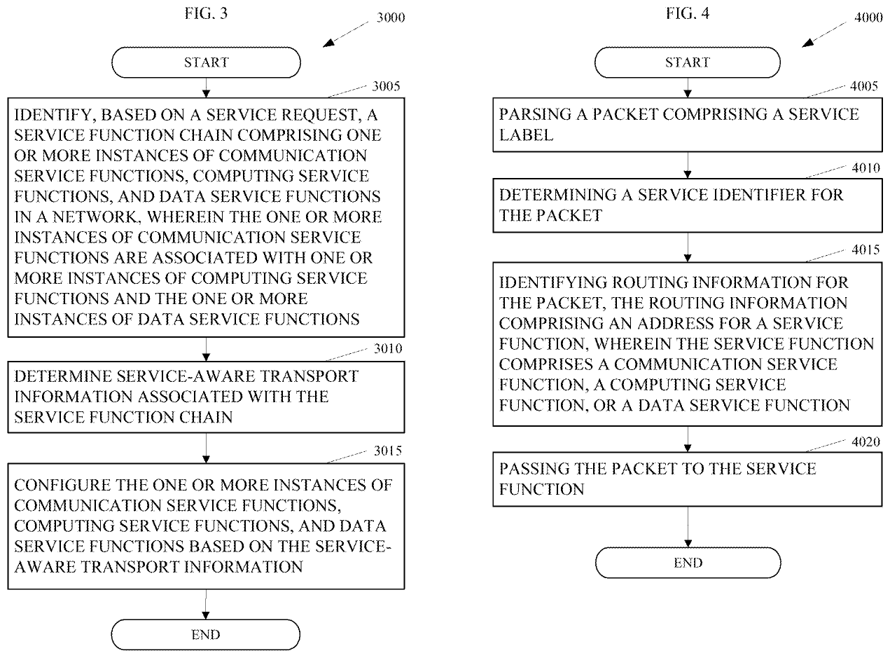

FIG. 5 depicts a flowchart 5000 of an embodiment for flow-based service-aware packet steering such as the embodiments described in conjunction with FIGS. 1A-1C, 2, 3, and 4. The flowchart 5000 begins with service logic circuitry of one or more nodes of a cellular network with cloud-based computing parsing a packet comprising a service label (element 5005). The service logic circuitry may parse a packet of a traffic flow at an instance of a Comm SF in a service function chain to determine an address in a service label of the packet (element 5010). The address in the service label of the packet may comprise, e.g., an IP address for an endpoint for the service function chain such as an IP address for a computing server cluster or a data server cluster.

The Comm SF may modify the packet to include an address for a service function for a next hop of the packet along the service function chain (element 5015). The address may identify a service function such as another instance of a Comm SF, a Comp SF, or a Data SF.

Based on the address for the service function for the next hop, the Comm SF may forward or transmit the packet to the service function (element 5020).

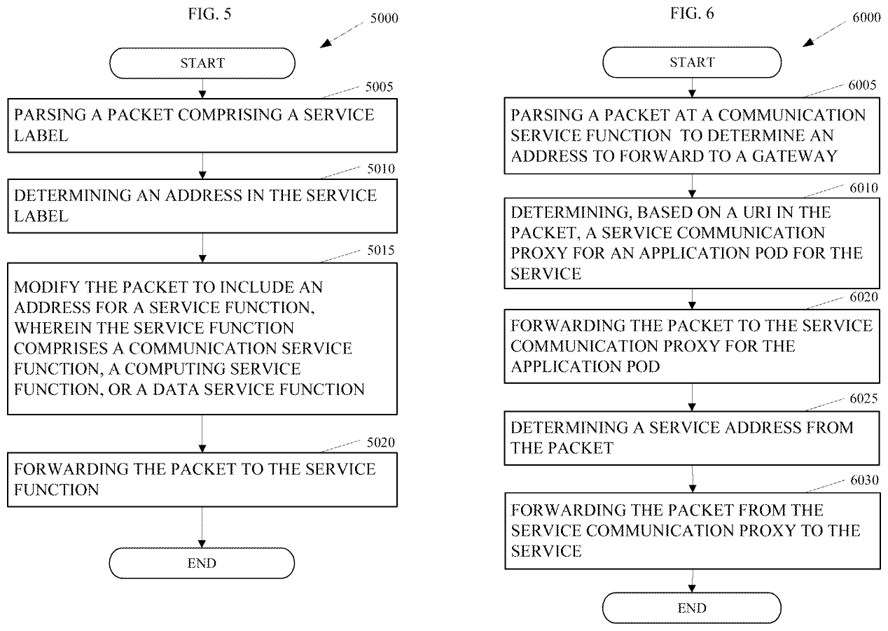

FIG. 6 depicts a flowchart 6000 of an embodiment for service-aware packet steering such as the embodiments described in conjunction with FIGS. 1A-1C, 2-4, and 5. The flowchart 6000 begins with service logic circuitry of one or more nodes of a cellular network with cloud-based computing parsing a packet at a Comm SF to determine an address for a Comp SF or Data SF with an eSCP-U GW (element 6005). For example, the Comm SF at the node of the cellular system connected to the Comp SF or Data SF that is the destination of the packet may determine the address for the Comp SF or Data. The Comp SF or the Data SF may comprise a gateway function, eSCP-U GW, configured to determine an application pod or eSCP-U for an application pod that is the next hop for the packet. The eSCP-U GWs and eSCP-Us in L7 perform service discovery, load balancing and communications based on, e.g., a uniform resource identifier (URI) defined in application logics, load balancing, and access control rules configured by the SICF. Based on a URI in the packet, the gateway function (eSCP-U GW) may determine the eSCP-U (element 6010) and may forward the packet to the eSCP-U for the application pod (element 6020).

The eSCP-U for the application pod may determine an address for a microservice for the packet (element 6025) and may forward the packet to from the eSCP-U to the microservice. In some embodiments, the eSCP-U GW may store the labels in the service label of the packet and add the labels of the service label to outgoing traffic from the microservice to steer the outgoing packet back to the user equipment that sent the packet to the microservice.

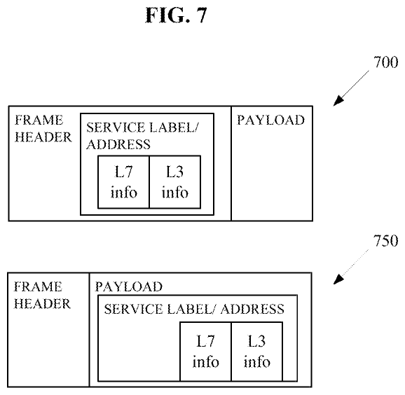

FIG. 7 depicts alternative embodiments for frames 700 and 750 of a packet for transport to and from physically distributed computing and data services such as the systems and processes described in conjunction with FIGS. 1A-1C, and 2-6. The frame 700 may comprise a portion of a packet comprising a service label added to the frame header. The service label may comprise layer 7 (L7) information and/or layer 3 (L3) information to steer a packet along a service function chain to/from a user equipment and from/to a service cluster such as a computing service cluster or a data service cluster of a logical cluster for a service function chain setup in response to a service request for a service by the UE. The L7 information may comprise, for instance, information about one or more eSCP-Us along a service function chain and the L3 information may comprise, for instance, an address for a service function that is a next hop along a service function chain for a packet.

The frame 750 may comprise a portion of a packet comprising a service label added to the payload or frame body. The service label may comprise L7 information and/or L3 information to steer a packet along a service function chain to/from a user equipment and from/to a service cluster.

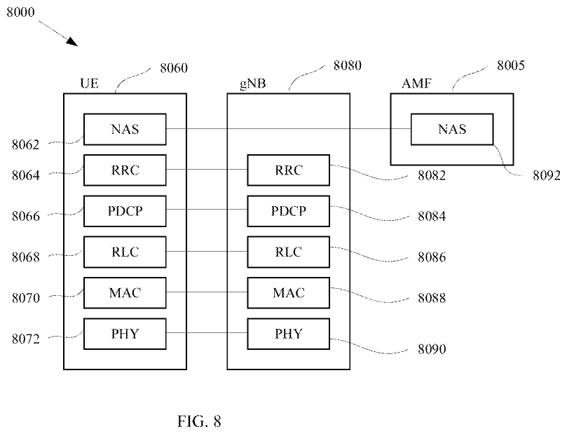

FIG. 8 depicts an embodiment of protocol entities 8000 that may be implemented in wireless communication devices, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects. In further embodiments, the NodeB may comprise an xNodeB for a 6^{th} generation or later NodeB.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

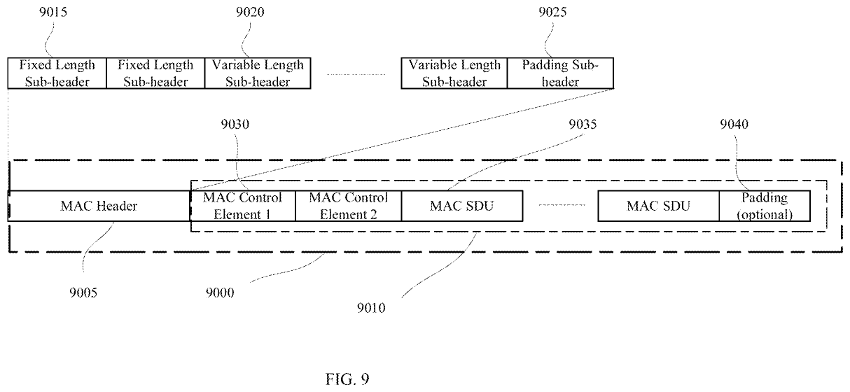

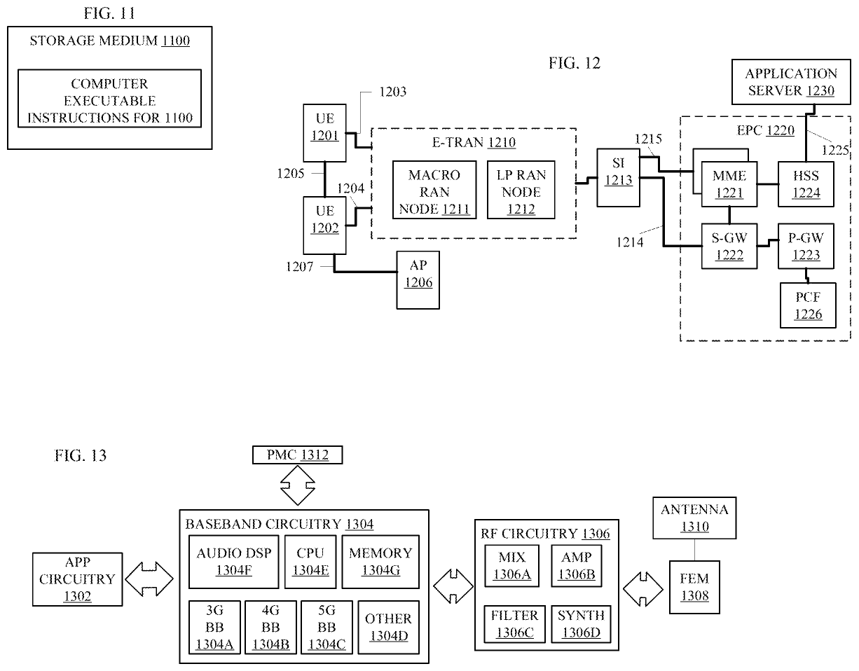

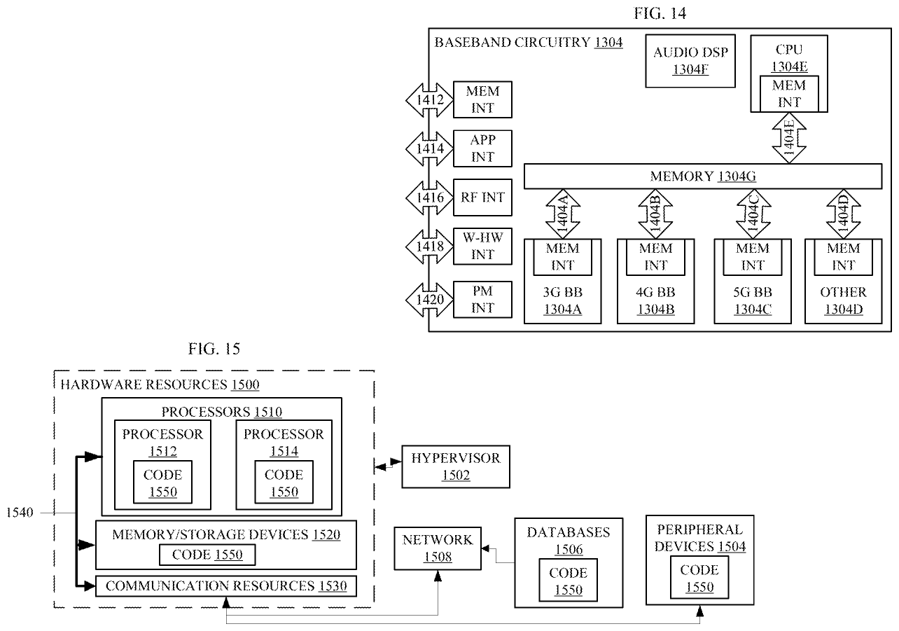

FIG. 9 illustrates embodiments of the formats of PHY data units (PDUs) that may be transmitted by the PHY device via one or more antennas and be encoded and decoded by a MAC entity such as the processors 203 and 213 in FIG. 2, the baseband circuitry 1304 in FIGS. 13 and 14 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

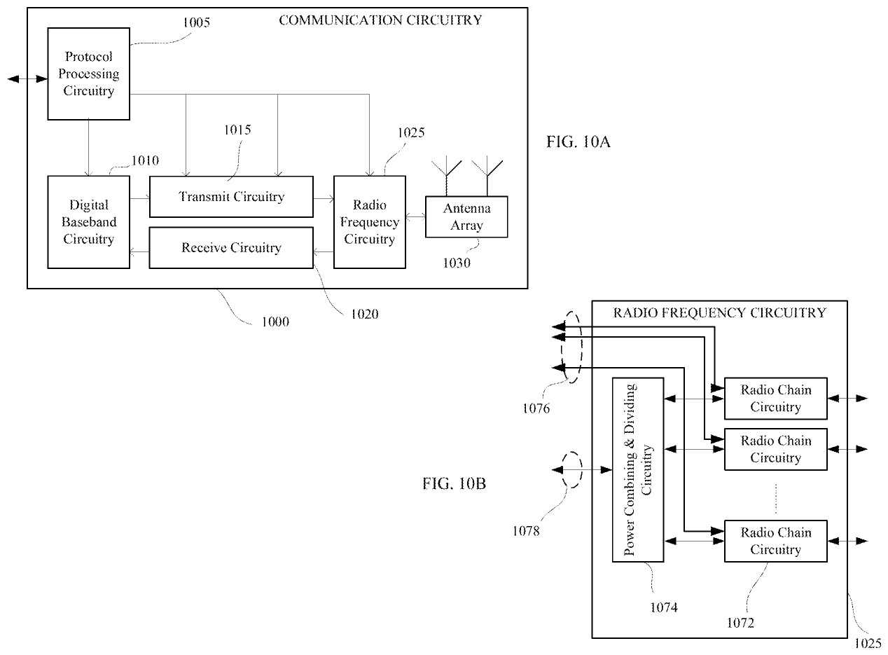

FIG. 10A illustrates an embodiment of communication circuitry 1000 such as the circuitry in the base station 201 and the user equipment 211 shown in FIG. 2. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 208 and 218 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 208 and 218 illustrated in FIG. 2. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

FIG. 11 illustrates an example of a storage medium 1100 to store code and data for execution by any one or more of the processors and/or processing circuitry to perform the functionality of the logic circuitry described herein. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 12 illustrates an architecture of a system 1200 of a network in accordance with some embodiments. The system 1200 is shown to include a user equipment (UE) 1201 and a UE 1202 such as the UEs shown in FIGS. 1A-1B, and 2. The UEs 1201 and 1202 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1201 and 1202 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 and 1202 may to connect, e.g., communicatively couple, with a radio access network (RAN)-in this embodiment, an Evolved Universal Mobile Telecommunications System (UMTS) Terrestrial Radio Access Network (E-UTRAN) 1210 such as the base stations shown in FIGS. 1A-1B, and 2. The UEs 1201 and 1202 utilize connections 1203 and 1204, respectively, each of which comprises a physical communications interface or layer (discussed in further detail below); in this example, the connections 1203 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1201 and 1202 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1202 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1203 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro RAN node 1211, and one or more RAN nodes for providing femto-cells or picocells (e.g., cells having smaller coverage areas, smaller user capacity, or higher bandwidth compared to macro-cells), e.g., low power (LP) RAN node 1212.

Any of the RAN nodes 1211 and 1212 can terminate the air interface protocol and can be the first point of contact for the UEs 1201 and 1202. In some embodiments, any of the RAN nodes 1211 and 1212 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1201 and 1202 can be configured to communicate using Orthogonal Frequency-Division Multiplexing (OFDM) communication signals with each other or with any of the RAN nodes 1211 and 1212 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 and 1212 to the UEs 1201 and 1202, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher-layer signaling to the UEs 1201 and 1202. The physical downlink control channel (PDCCH) may carry information about the transport format and resource allocations related to the PDSCH channel, among other things. It may also inform the UEs 1201 and 1202 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1211 and 1212 based on channel quality information fed back from any of the UEs 1201 and 1202. The downlink resource assignment information may be sent on the PDCCH used for (e.g., assigned to) each of the UEs 1201 and 1202.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1211 and 1212 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network-in this embodiment, an Evolved Packet Core (EPC) network 1220 via an SI interface 1213. In this embodiment the SI interface 1213 is split into two parts: the SI-U interface 1214, which carries traffic data between the RAN nodes 1211 and 1212 and the serving gateway (S-GW) 1222, and the SI-mobility management entity (MME) interface 1215, which is a signaling interface between the RAN nodes 1211 and 1212 and MMEs 1221.

In this embodiment, the EPC network 1220 comprises the MMEs 1221, the S-GW 1222, the Packet Data Network (PDN) Gateway (P-GW) 1223, and a home subscriber server (HSS) 1224. The MMEs 1221 may be similar in function to the control plane of legacy Serving General Packet Radio Service (GPRS) Support Nodes (SGSN). The MMEs 1221 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the SI interface 1213 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VOIP) sessions, PTT sessions, group communication sessions, social networking services, etc.) for the UEs 1201 and 1202 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QOS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs shown in FIGS. 1A-1B, 2, and 12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/0) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuity 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 201 and the user equipment 211 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown in FIGS. 1A, 2, and 13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. For instance, identifying, based on a service request received via the network interface, a service function chain may advantageously provide a chain of control plane service functions to direct a traffic flow to and from physically distributed computing and data services. Determining service-aware transport information associated with the service function chain may advantageously determine a hop information for service-aware transport of packets. Configuring, via one or more interfaces, the one or more instances of communication service functions, computing service functions, and data service functions for packet steering based on the service-aware transport information may advantageously configure proxies and service functions such as communication service functions, computing service functions, and data service functions to transport traffic to and from physically distributed computing and data service clusters with a hybrid of service mesh and service-aware transport.

### EXAMPLES OF FURTHER EMBODIMENTS

The following examples pertain to further embodiments. Specifics in the examples may be used anywhere in one or more embodiments.

Example 1 is an apparatus of a first base station for service function chaining and packet steering, comprising one or more interfaces for network communications; logic circuitry coupled with the interface to perform operations to identify, based on a service request received via the network interface, a service function chain comprising one or more instances of a communication service function, one or more instances of a computing service function, and one or more instances of a data service function in a network, wherein the one or more instances of the communication service function are associated with one or more instances of the computing service function and the one or more instances of the data service function; determine service-aware transport information associated with the service function chain; and configure, via the one or more interfaces, the one or more instances of the communication service function, the computing service function, and the data service function for packet steering based on the service-aware transport information. In Example 2, the apparatus of Example 1, wherein the logic circuitry comprises a processor and a memory coupled with the processor, the apparatus further comprising a radio frequency circuitry coupled with the logic circuitry, and one or more antennas coupled with the radio frequency circuitry. In Example 3, the apparatus of Example 1, wherein the one or more instances of the computing service function are associated with one or more physically distributed computing service clusters, and the one or more instances of the data service function are associated with one or more physically distributed data service clusters. In Example 4, the apparatus of Example 1, wherein identification of the one or more instances of the communication service function comprises identification of each instance of the communication service function associated with a hop between nodes of the network from an access node connected to a user equipment to one or more access nodes connected to physical computing and data resources associated with the service request. In Example 5, the apparatus of Example 4, wherein identification of the one or more instances of the computing service function and the one or more instances of the data service function comprises identification of each instance of a gateway service function and a service function proxy associated with the physical computing and data resources for the service request. In Example 6, the apparatus of Example 5, wherein determination of the service-aware transport information comprises determination of addresses for the instances of the service functions, proxies, and services associated with the physical computing and data resources for the service request for a flow-based service-aware transport scheme or a packet-based service-aware transport scheme. In Example 7, the apparatus of any Example 1-4, the logic circuitry to perform further operations to parse a service label of a packet associated with a service identified in the service request to determine an address associated with the service label and forward the packet to an instance of a service function of the service function chain based on the address, wherein the instance of the service function comprises one instance of the one or more instances of the computing service function, the data service function, and the communication service function in the network. In Example 8. The apparatus of any Example 1-4, the logic circuitry to perform further operations to parse a service label of a packet associated with a service identified in the service request to determine a service identifier associated with the service label; and forward the packet to an instance of a service function of the service function chain based on the service identifier, wherein the instance of the service function comprises one instance of the one or more instances of the computing service function, the data service function, and the communication service function in the network.

Example 9 is a method for service function chaining and packet steering, comprising identifying, based on a service request received via a network interface, a service function chain comprising one or more instances of a communication service function, one or more instances of a computing service function, and one or more instances of a data service function in a network, wherein the one or more instances of the communication service function are associated with the one or more instances of the computing service function and the one or more instances of the data service function; determining service-aware transport information associated with the service function chain; and configuring, via one or more interfaces, the one or more instances of the communication service function, the computing service function, and the data service function for packet steering based on the service-aware transport information. In Example 10, the method of Example 9, wherein the one or more instances of the computing service function are associated with one or more physically distributed computing service clusters, and the one or more instances of the data service function are associated with one or more physically distributed data service clusters. In Example 11, the method of Example 9, wherein identification of the one or more instances of the communication service function comprises identification of each instance of the communication service function associated with a hop between nodes of the network from an access node connected to a user equipment to one or more access nodes connected to physical computing and data resources associated with the service request. In Example 12, the method of Example 11, wherein identification of the one or more instances of the computing service function and the one or more instances of the data service function comprises identification of each instance of a gateway service function and a service function proxy associated with the physical computing and data resources for the service request. In Example 13, the method of Example 12, wherein determination of the service-aware transport information comprises determination of addresses for the instances of the service functions, proxies, and services associated with the physical computing and data resources for the service request for a flow-based service-aware transport scheme or a packet-based service-aware transport scheme. In Example 14, the method of any Example 9-11, further comprising parsing a service label of a packet associated with a service identified in the service request to determine an address associated with the service label and forwarding the packet to an instance of a service function of the service function chain based on the address, wherein the instance of the service function comprises one instance of the one or more instances of the computing service function, the data service function, and the communication service function in the network.

Example 15 is a machine-readable medium containing instructions at a first base station for mobile communication, which when executed by a processor, cause the processor to perform operations for service function chaining and packet steering, the operations to identify, based on a service request received via a network interface, a service function chain comprising one or more instances of a communication service function, one or more instances of a computing service function, and one or more instances of a data service function in a network, wherein the one or more instances of the communication service function are associated with the one or more instances of the computing service function and the one or more instances of the data service function; determine service-aware transport information associated with the service function chain; and configure, via one or more interfaces, the one or more instances of communication service function, the computing service function, and the data service function for packet steering based on the service-aware transport information. In Example 16, the machine-readable medium of Example 15, wherein the one or more instances of the computing service function are associated with one or more physically distributed computing service clusters, and the one or more instances of the data service function are associated with one or more physically distributed data service clusters. In Example 17, the machine-readable medium of Example 15, wherein identification of the one or more instances of the computing service function and the one or more instances of the data service function comprises identification of each instance of a gateway service function and a service function proxy associated with the physical computing and data resources for the service request. In Example 18, the machine-readable medium of Example 17, wherein determination of the service-aware transport information comprises determination of addresses for instances of the service functions, proxies, and services associated with the physical computing and data resources for the service request for a flow-based service-aware transport scheme or a packet-based service-aware transport scheme. In Example 19, the machine-readable medium of Example 18, wherein identification of the one or more instances of the communication service function comprises identification of each instance of the communication service function associated with a hop between nodes of the network from an access node connected to a user equipment to one or more access nodes connected to physical computing and data resources associated with the service request. In Example 20, the machine-readable medium of any Example 15-17, the operations further to parse a service label of a packet associated with a service identified in the service request to determine an address associated with the service label and forward the packet to an instance of a service function of the service function chain based on the address, wherein the instance of the service function comprises one of the one or more instances of the computing service function, data service function, and communication service function in the network. Example 21 is an apparatus comprising a means for any Example 9-14.

1-20. (canceled)

21. An apparatus of a base station, comprising:
one or more interfaces for network communications;
logic circuitry coupled with the interface to perform operations to:
identify, based on a service request received via the network interface, a service function chain comprising one or more instances of a communication service function, one or more instances of a computing service function, and one or more instances of a data service function in a network, wherein the one or more instances of the communication service function are associated with one or more instances of the computing service function and the one or more instances of the data service function;
determine service-aware transport information associated with the service function chain; and
configure, via the one or more interfaces, the one or more instances of the communication service function, the computing service function, and the data service function for packet steering based on the service-aware transport information.

22. The apparatus of claim 21, wherein the logic circuitry comprises a processor and a memory coupled with the processor, the apparatus further comprising a radio frequency circuitry coupled with the logic circuitry, and one or more antennas coupled with the radio frequency circuitry.

23. The apparatus of claim 21, wherein the one or more instances of the computing service function are associated with one or more physically distributed computing service clusters, and the one or more instances of the data service function are associated with one or more physically distributed data service clusters.

24. The apparatus of claim 21, wherein identification of the one or more instances of the communication service function comprises identification of each instance of the communication service function associated with a hop between nodes of the network from an access node connected to a user equipment to one or more access nodes connected to physical computing and data resources associated with the service request.

25. The apparatus of claim 24, wherein identification of the one or more instances of the computing service function and the one or more instances of the data service function comprises identification of each instance of a gateway service function and a service function proxy associated with the physical computing and data resources for the service request.

26. The apparatus of claim 25, wherein determination of the service-aware transport information comprises determination of addresses for the instances of the service functions, proxies, and services associated with the physical computing and data resources for the service request for a flow-based service-aware transport scheme or a packet-based service-aware transport scheme.

27. The apparatus of claim 21, the logic circuitry to perform further operations to:
parse a service label of a packet associated with a service identified in the service request to determine an address associated with the service label; and
forward the packet to an instance of a service function of the service function chain based on the address, wherein the instance of the service function comprises one instance of the one or more instances of the computing service function, the data service function, and the communication service function in the network.

28. The apparatus of claim 21, the logic circuitry to perform further operations to:
parse a service label of a packet associated with a service identified in the service request to determine a service identifier associated with the service label; and
forward the packet to an instance of a service function of the service function chain based on the service identifier, wherein the instance of the service function comprises one instance of the one or more instances of the computing service function, the data service function, and the communication service function in the network.

29. A method, comprising:
identifying, based on a service request received via a network interface, a service function chain comprising one or more instances of a communication service function, one or more instances of a computing service function, and one or more instances of a data service function in a network, wherein the one or more instances of the communication service function are associated with the one or more instances of the computing service function and the one or more instances of the data service function;
determining service-aware transport information associated with the service function chain; and
configuring, via one or more interfaces, the one or more instances of the communication service function, the computing service function, and the data service function for packet steering based on the service-aware transport information.

30. The method of claim 29, wherein the one or more instances of the computing service function are associated with one or more physically distributed computing service clusters, and the one or more instances of the data service function are associated with one or more physically distributed data service clusters.

31. The method of claim 29, wherein identification of the one or more instances of the communication service function comprises identification of each instance of the communication service function associated with a hop between nodes of the network from an access node connected to a user equipment to one or more access nodes connected to physical computing and data resources associated with the service request.

32. The method of claim 31, wherein identification of the one or more instances of the computing service function and the one or more instances of the data service function comprises identification of each instance of a gateway service function and a service function proxy associated with the physical computing and data resources for the service request.

33. The method of claim 32, wherein determination of the service-aware transport information comprises determination of addresses for the instances of the service functions, proxies, and services associated with the physical computing and data resources for the service request for a flow-based service-aware transport scheme or a packet-based service-aware transport scheme.

34. The method of claim 29, further comprising:
parsing a service label of a packet associated with a service identified in the service request to determine an address associated with the service label; and
forwarding the packet to an instance of a service function of the service function chain based on the address, wherein the instance of the service function comprises one instance of the one or more instances of the computing service function, the data service function, and the communication service function in the network.

35. A machine-readable medium containing instructions at a base station, which when executed by a processor, cause the processor to perform operations for service function chaining and packet steering, the operations to:
identify, based on a service request received via a network interface, a service function chain comprising one or more instances of a communication service function, one or more instances of a computing service function, and one or more instances of a data service function in a network, wherein the one or more instances of the communication service function are associated with the one or more instances of the computing service function and the one or more instances of the data service function;
determine service-aware transport information associated with the service function chain; and
configure, via one or more interfaces, the one or more instances of communication service function, the computing service function, and the data service function for packet steering based on the service-aware transport information.

36. The machine-readable medium of claim 35, wherein the one or more instances of the computing service function are associated with one or more physically distributed computing service clusters, and the one or more instances of the data service function are associated with one or more physically distributed data service clusters.

37. The machine-readable medium of claim 35, wherein identification of the one or more instances of the computing service function and the one or more instances of the data service function comprises identification of each instance of a gateway service function and a service function proxy associated with the physical computing and data resources for the service request.

38. The machine-readable medium of claim 37, wherein determination of the service-aware transport information comprises determination of addresses for instances of the service functions, proxies, and services associated with the physical computing and data resources for the service request for a flow-based service-aware transport scheme or a packet-based service-aware transport scheme.

39. The machine-readable medium of claim 38, wherein identification of the one or more instances of the communication service function comprises identification of each instance of the communication service function associated with a hop between nodes of the network from an access node connected to a user equipment to one or more access nodes connected to physical computing and data resources associated with the service request.

40. The machine-readable medium of claim 35, the operations further to:
parse a service label of a packet associated with a service identified in the service request to determine an address associated with the service label; and
forward the packet to an instance of a service function of the service function chain based on the address, wherein the instance of the service function comprises one of the one or more instances of the computing service function, data service function, and communication service function in the network.
